(19) United States
(12) Patent Application Publication
(10) Pub. No.: US 2024/0399929 A1
(43) Pub. Date: Dec. 5, 2024

(54) ADAPTIVE HIGH VOLTAGE BATTERY COOLING

(71) Applicant: FCA US LLC, Auburn Hills, MI (US)

(72) Inventor: Brian K. Barnes, Holly, MI (US)

(21) Appl. No.: 18/326,525

(22) Filed: May 31, 2023

(51) Int. Cl. B60L 58/26; B60H 1/00; H01M 10/613; H01M 10/625; H01M 10/633; H01M 10/663

(52) U.S. Cl. CPC B60L 58/26; B60H 1/00278; H01M 10/613; H01M 10/625; H01M 10/633; H01M 10/663; B60H 2001/00307; B60K 11/02; B60L 2240/545

(57) ABSTRACT

A vehicle thermal system includes a battery system coolant loop including a pump (BCP) configured to circulate a first coolant for cooling a high voltage (HV) battery, and an HVAC loop including a compressor and a chiller thermally coupled to the battery system coolant loop, the compressor configured to circulate a second coolant to the chiller to cool to the battery system coolant loop. A HV battery cooling system includes a controller configured to execute an adaptive cooling strategy operation to proactively cool the HV battery, including determining the HV battery has surpassed a predetermined maximum allowable battery temperature, determining a Desired Time to Cool the HV battery to or below the maximum allowable battery temperature, and initiating an active cooling of the HV battery by opening the chiller flow control valve and operating the BCP and/or the compressor to cool the HV battery within the Desired Time to Cool.

### FIELD

The present application relates generally to vehicle thermal systems and, more particularly, to vehicle thermal systems with adaptive high voltage battery cooling control.

### BACKGROUND

High voltage (HV) batteries in plug-in hybrid electric vehicles (PHEVs) and battery electric vehicles (BEVs) often experience high heat generation during vehicle use, which can potentially result in degraded battery performance. Accordingly, such vehicles typically include one or more cooling systems to maintain the HV batteries at a desired temperature. However, these conventional cooling systems are only reactive to the actual HV battery temperature and can lead to HV battery overtemperature since cooling ramps in slowly regardless of how quickly the HV battery is heating up. Accordingly, while such vehicle thermal systems work well for their intended purpose, there is a desire for improvement in the relevant art.

### SUMMARY

In accordance with one example aspect of the invention, an electric vehicle thermal system is provided. In one example, the thermal system includes a battery system coolant loop including a battery coolant pump (BCP) configured to circulate a first coolant for cooling a high voltage (HV) battery, an HVAC loop including a compressor and a chiller thermally coupled to the battery system coolant loop, the compressor configured to circulate a second coolant to the chiller to provide cooling to the battery system coolant loop, and an HV battery cooling system including a controller in signal communication with the BCP, the compressor, and a flow control valve of the chiller. The controller includes one or more processors and is configured to execute an adaptive cooling strategy operation to proactively cool the HV battery. The adaptive cooling strategy operation includes determining the HV battery has surpassed a predetermined maximum allowable battery temperature, determining a Desired Time to Cool the HV battery to or below the maximum allowable battery temperature, and initiating an active cooling of the HV battery by opening the chiller flow control valve and operating the BCP and/or the compressor to cool the HV battery to or below the maximum allowable battery temperature within the Desired Time to Cool the HV battery.

In addition to the foregoing, the described electric vehicle thermal system may include one or more of the following features: wherein the controller initiates the active cooling when a predicted time to cool the HV battery to or below the maximum allowable battery temperature while operating the BCP and/or the compressor in a predetermined power efficiency zone, is less than a time remaining of the Desired Time to Cool since the predetermined maximum allowable battery temperature was surpassed; wherein the predetermined power efficiency zone is a most efficient operation of the BCP and compressor; and wherein the controller determines the predicted time to cool the HV battery by determining how much generated battery heat energy must be dissipated during the Desired Time to Cool, and subsequently dividing by a most efficient operation of the BCP and compressor.

In addition to the foregoing, the described electric vehicle thermal system may include one or more of the following features: wherein the controller determines how much generated battery heat energy must be dissipated during the Desired Time to Cool by determining a total battery heat energy generated by the HV battery that comprises the sum of (i) how much heat energy has been generated by the HV battery and (ii) how much additional heat energy will be generated by the HV battery by the end of the Desired Time to Cool; and wherein the controller determines the additional heat energy generated by the HV battery by the end of the Desired Time to Cool by multiplying the Desired Time to Cool by a rolling average of additional battery heat energy that will be generated during the remaining Desired Time to Cool.

In addition to the foregoing, the described electric vehicle thermal system may include one or more of the following features: wherein the controller determines how much heat energy has been generated by the HV battery by: determining a battery efficiency of the HV battery, determining a percentage of battery discharge power that is being converted into heat, based on the determined battery efficiency, determining a battery heat generated by the HV battery based on the percentage of battery discharge power being converted into heat and a determined battery discharge power of the HV battery, and integrating the battery heat generated over a time since the predetermined maximum allowable battery temperature was surpassed.

In addition to the foregoing, the described electric vehicle thermal system may include one or more of the following features: wherein once the active cooling is initiated, the controller further executes the adaptive cooling strategy operation to proactively cool the HV battery by: determining any additional battery heat energy generated by the HV battery during the Desired Time to Cool due to a change in driving behavior, determining an additional battery cooling power needed to cool the additional battery heat energy generated by the HV battery during the Desired Time to Cool due to a change in driving behavior, determining a first operational speed of the BCP and a second operational speed of the compressor required to provide the determined additional battery cooling power needed, commanding the BCP to operate at the first operational speed, and commanding the compressor to operate at the second operational speed.

In addition to the foregoing, the described electric vehicle thermal system may include one or more of the following features: wherein the first operational speed and the second operational speed are the most efficient operational speeds of the BCP and the compressor to provide the determined additional battery cooling power needed; and wherein the controller determines the first and second operational speeds based on a lookup table that charts various operating speeds of the BCP and compressor and a corresponding battery cooling power produced by the BCP and compressor when operating at those various operating speeds.

In accordance with another example aspect of the invention, a method for adaptively cooling a high voltage (HV) battery in an electric vehicle thermal system is provided. In on example, the electric vehicle thermal system includes a battery system coolant loop including a battery coolant pump (BCP) configured to circulate a first coolant for cooling the HV battery, an HVAC loop including a compressor and a chiller thermally coupled to the battery system coolant loop, the compressor configured to circulate a second coolant to the chiller to provide cooling to the battery system coolant loop, and an HV battery cooling system including a controller, having one or more processors, in signal communication with the BCP, the compressor, and a flow control valve of the chiller.

The example method includes determining, with controller, the HV battery has surpassed a predetermined maximum allowable battery temperature; determining, with the controller, a Desired Time to Cool the HV battery to or below the maximum allowable battery temperature; and initiating, with the controller, an active cooling of the HV battery by opening the chiller flow control valve and operating the BCP and/or the compressor to cool the HV battery to or below the maximum allowable battery temperature within the Desired Time to Cool the HV battery.

In addition to the foregoing, the described method may include one or more of the following features: wherein the controller initiates the active cooling when a predicted time to cool the HV battery to or below the maximum allowable battery temperature while operating the BCP and/or the compressor in a predetermined power efficiency zone, is less than a time remaining of the Desired Time to Cool since the predetermined maximum allowable battery temperature was surpassed; and wherein the predetermined power efficiency zone is a most efficient operation of the BCP and compressor; wherein the controller determines the predicted time to cool the HV battery by determining how much generated battery heat energy must be dissipated during the Desired Time to Cool, and subsequently dividing by a most efficient operation of the BCP and compressor.

In addition to the foregoing, the described method may include one or more of the following features: wherein the controller determines how much generated battery heat energy must be dissipated during the Desired Time to Cool by determining a total battery heat energy generated by the HV battery that comprises the sum of (i) how much heat energy has been generated by the HV battery and (ii) how much additional heat energy will be generated by the HV battery by the end of the Desired Time to Cool; and wherein the controller determines the additional heat energy generated by the HV battery by the end of the Desired Time to Cool by multiplying the Desired Time to Cool by a rolling average of additional battery heat energy that will be generated during the remaining Desired Time to Cool.

In addition to the foregoing, the described method may include one or more of the following features: wherein the controller determines how much heat energy has been generated by the HV battery by: determining a battery efficiency of the HV battery; determining a percentage of battery discharge power that is being converted into heat, based on the determined battery efficiency; determining a battery heat generated by the HV battery based on the percentage of battery discharge power being converted into heat and a determined battery discharge power of the HV battery; and integrating the battery heat generated over a time since the predetermined maximum allowable battery temperature was surpassed.

In addition to the foregoing, the described method may include one or more of the following features: once the active cooling is initiated, determining, with the controller, any additional battery heat energy generated by the HV battery during the Desired Time to Cool due to a change in driving behavior; determining, with the controller, an additional battery cooling power needed to cool the additional battery heat energy generated by the HV battery during the Desired Time to Cool due to a change in driving behavior; determining, with the controller, a first operational speed of the BCP and a second operational speed of the compressor required to provide the determined additional battery cooling power needed; commanding, with the controller, the BCP to operate at the first operational speed; and commanding, with the controller, the compressor to operate at the second operational speed.

In addition to the foregoing, the described method may include one or more of the following features: wherein the first operational speed and the second operational speed are the most efficient operational speeds of the BCP and the compressor to provide the determined additional battery cooling power needed; and wherein the controller determines the first and second operational speeds based on a lookup table that charts various operating speeds of the BCP and compressor and a corresponding battery cooling power produced by the BCP and compressor when operating at those various operating speeds.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle thermal system having an adaptive high voltage battery cooling system, in accordance with the principles of the present application;

FIG. 2 illustrates an example control strategy for determining when to begin cooling a high voltage battery of the system of FIG. 1, in accordance with the principles of the present application;

FIG. 3 illustrates an example control strategy for operating the thermal system of FIG. 1 once cooling of the high voltage battery begins, in accordance with the principles of the present application; and

FIG. 4 is a flow diagram of an example method of cooling a high voltage battery of the system of FIG. 1, in accordance with the principles of the present application.

### DETAILED DESCRIPTION

As previously described, typical cooling systems for electric vehicle (EV) high voltage (HV) batteries operate reactively to the HV battery temperature. The higher the HV battery temperature at the current time, the more cooling the system applies. However, reactive cooling can lead to HV battery overtemperature since cooling often ramps in slowly regardless of how quickly the HV battery is heating up. Accordingly, systems and methods are described herein for an adaptive HV battering cooling strategy to more precisely and efficiently control the HV battery cooling in EVs. In one example, the strategy includes refined control of an electric A/C compressor (EAC), battery coolant pump (BCP), and chiller refrigerant valve (CRV). It will be appreciated that the term EV encompasses various electric-type vehicles such as BEVs, PHEVs, etc.

The example adaptive HV battery cooling system is configured to operate proactively rather than reactively to HV battery temperature. Utilizing the EAC, BCP, and CRV, the system enables the battery cooling to respond based on HV battery usage and heating rate rather than its current temperature. Accordingly, if the HV battery is heating up rapidly, the system can better match the heat generation with cooling power by operating the EAC, BCP, and CRV response more aggressively. This results in longer electric drive due to improved HV battery cooling, as well as a more predictable overtemperature time as the system takes into account time allowed overtemperature.

In one example operation, the adaptive HV battery cooling system receives as input a HV battery discharge current and an internal resistance to thereby calculate the heat being generated by the HV battery. The system tracks the generated heat and integrates it over the time allowed overtemperature to determine at what time the EAC, BCP, and CRV should begin operation at their most efficient points. In this way, HV battery cooling will occur at different points for different use cases, which would increase the electric drive allowed time and potentially increase fuel economy due to more efficient operation of the EAC, BCP, and CRV. The system will also better track the time overtemperature and with a calibration change can even be adjusted to allow more or less total time in the overtemperature range.

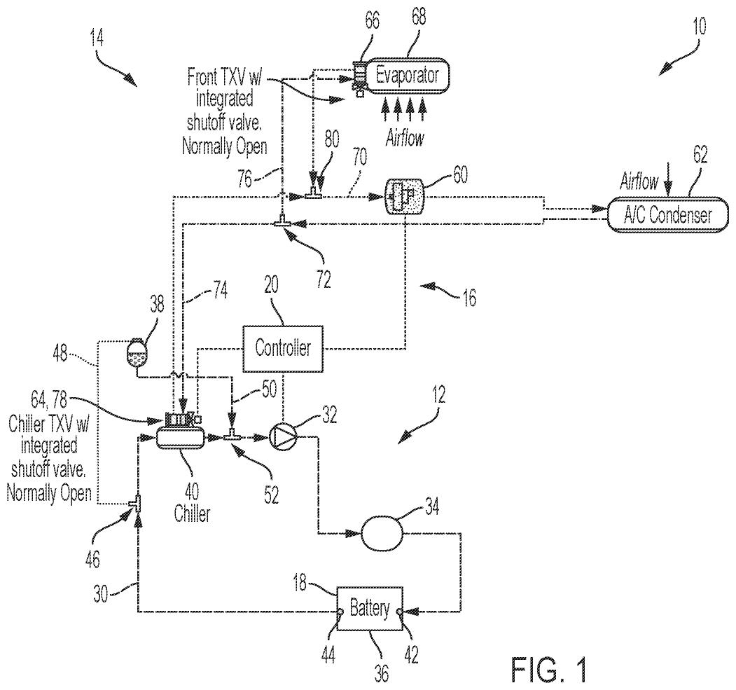

With initial reference to FIG. 1, an example electric vehicle thermal system is illustrated and generally identified at reference numeral 10. In the example embodiment, the EV thermal system 10 generally includes a battery system coolant loop 12 and an HVAC loop 14. Although not shown, the EV thermal system 10 can also include a high temperature coolant loop for cooling an internal combustion engine, as well as a low temperature coolant loop for heating/cooling various components of the vehicle such as power electronics including an integrated dual charging module (IDCM), a power inverter module (PIM), and an electric motor.

The EV thermal system 10 also includes an adaptive HV battery cooling system 16 configured to cool one or more HV batteries 18 that power the electric motor to propel the vehicle, as described herein in more detail. The EV thermal system 10 and HV battery cooling system 16 include or are in signal communication with one or more controllers 20, such as an engine control unit (ECU) or hybrid control processor (HCP), which is signal communication with various components, valves, and sensors.

With continued reference to FIG. 1, in the example embodiment, the battery system coolant loop 12 generally includes a main circuit 30, a battery coolant pump (BCP) 32, a HV heater 34, a heat exchanger 36, an overflow bottle 38, and a chiller 40. The BCP 32 is configured to circulate coolant around the main circuit 30 and includes an outlet to direct coolant to the HV heater 34, which is configured to selectively heat the coolant passing through the main circuit 30 to subsequently heat the HV battery 18 via heat exchanger 36 when desired (e.g., during a cold start). Additionally, a first temperature sensor 42 and a second temperature sensor 44 are in signal communication with controller 20 and respectively disposed on the main circuit 30 upstream and downstream of the heat exchanger 36. In this way, controller 20 can operate the HV battery cooling system 16 based at least in part on one or more signals from the temperature sensors 42, 44 indicative of the coolant temperature in the main circuit 30 and/or a temperature of the HV battery 18.

The main circuit 30 includes a first junction 46 downstream of the heat exchanger 36. The overflow bottle 38 is configured to receive coolant overflow (e.g., vaporized coolant) from the main circuit 30 via an overflow line 48 connected to the first junction 46. The overflow bottle 38 subsequently directs the received coolant back to the main circuit 30 via a return line 50, which is fluidly coupled to a second junction 52 located downstream of the chiller 40 and upstream of the BCP 32. Coolant that does not flow to the overflow bottle 38 is directed to the chiller 40. The chiller 40 is thermally coupled to the HVAC loop 14 and is configured to selectively utilize HVAC refrigerant to indirectly cool the coolant of the battery system coolant loop 12 passing therethrough. In this way, the coolant in main circuit 30 is cooled in the chiller and returned to the BCP 32, which subsequently circulates the coolant to the heat exchanger 36 for cooling of the HV battery 18.

In the example implementation, the HVAC loop 14 is a standard vehicle air conditioning system that generally includes a compressor 60 (e.g., electric A/C compressor—EAC), a condenser 62, a first expansion device 64, the chiller 40, a second expansion device 66, and an evaporator 68.

In operation, a suction line 70 provides gaseous refrigerant to compressor 60, which subsequently compresses the refrigerant. The compressed and heated refrigerant is then directed to the condenser 62 where the heat from compression is dissipated and the refrigerant condenses to a liquid. The liquid refrigerant is then directed to a first junction 72, which divides the coolant flow into a first branch 74 and a second branch 76.

The first branch 74 is configured to supply refrigerant to the first expansion device 64, which is a thermal expansion valve with an integrated chiller refrigerant valve (CRV) 78. In the example embodiment, the CRV 78 is movable anywhere between fully open and fully closed positions to control the amount of refrigerant flowing through first branch 74 to the chiller 40, thereby controlling the amount of cooling capacity provided by the chiller 40. When the CRV 78 is in the fully closed position, refrigerant is prevented from flowing through first branch 74. When the CRV 78 is in a partially open or fully open position, refrigerant is able to flow through the first branch 74 to the first expansion device 64 where it is reduced in pressure and at least partially vaporized, thereby reducing the temperature of the refrigerant. The cooled refrigerant is then supplied to chiller 40, where it is evaporated to provide cooling to the coolant circulating within the battery system coolant loop 12. The resulting gaseous, warmed refrigerant is then returned to the compressor 60 via a second junction 80 to the suction line 70 where the cycle is then repeated.

The second branch 76 is configured to supply refrigerant to the second expansion device 66 (e.g., thermal expansion valve with integrated flow control valve), where it is reduced in pressure and at least partially vaporized, thereby reducing the temperature of the refrigerant. The cooled refrigerant is then supplied to evaporator 68, where it is evaporated to providing cooling to the vehicle cabin. The resulting gaseous, warmed refrigerant is then returned to the compressor 60 via the second junction 80 to the suction line 70 and the cycle is repeated.

With continued reference to FIG. 1, the HV battery cooling system 16 of the vehicle thermal system 10 will be described in more detail. In the example embodiment, the HV battery cooling system 16 is configured proactively cool the HV battery 18 during vehicle use and generally includes controller 20 in signal communication with BCP 32, EAC 60, and CRV 78.

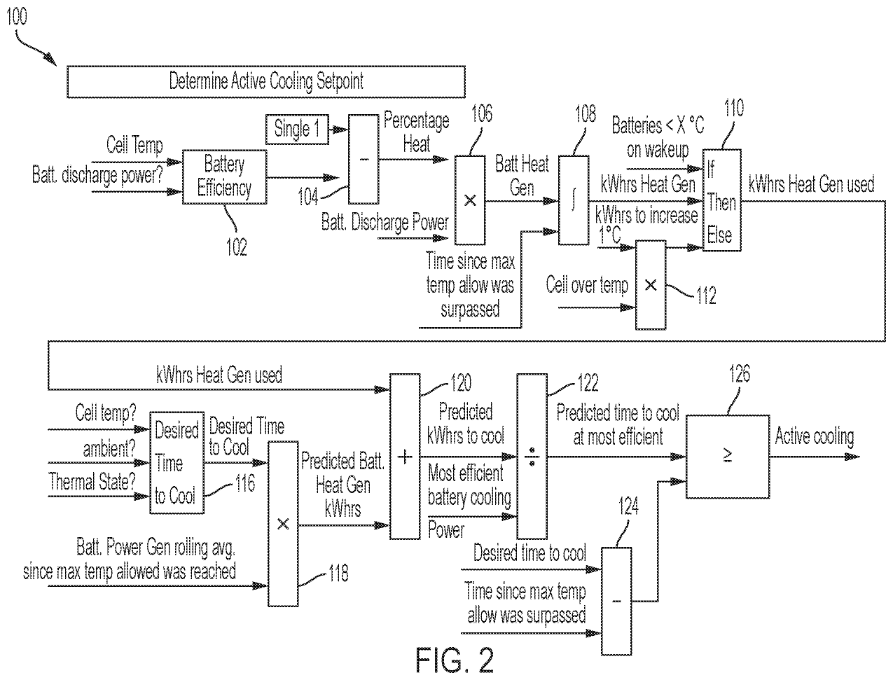

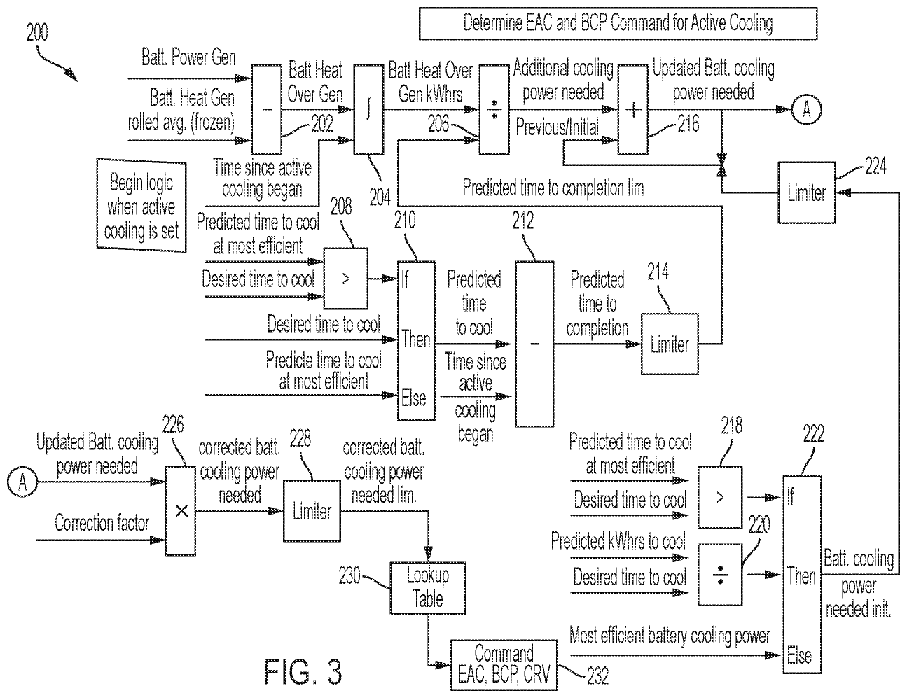

With reference now to FIGS. 2 and 3, an example computer-implemented control strategy for operating HV battery cooling system 16 to cool HV battery 18 is provided. FIG. 2 illustrates an example computer-implemented control strategy 100 for determining when to begin cooling the HV battery 18, and FIG. 3 illustrates an example computer-implemented control strategy 200 for determining how to operate the BCP 32, EAC 60, and CRV 78 once cooling of the HV battery 18 begins.

Turning now to FIG. 2, the control strategy 100 begins at block 102 and controller 20 determines a Battery Efficiency of HV battery 18 based on received inputs. In the example embodiment, inputs include a Cell Temperature and a Battery Discharge Power of HV battery 18. The Cell Temperature may be determined, for example, via one or more temperature sensors such as temperature sensors 42, 44. Battery Discharge Power may be determined, for example, via battery manufacturer supplied internal resistance tables that determine how much heat is being generated by the HV battery 18. In the example embodiment, Battery Discharge Power is a signal sent by the HV battery 18 as current draw multiplied by a measured voltage, and the generated heat is calculated via the internal resistance tables and current draw.

At block 104, controller 20 determines a percentage of battery discharge power that is being converted into heat (Percentage Heat) based on the integer one (“single 1”) minus the Battery Efficiency determined in block 102. For example, if the determined battery efficiency is 90% (0.90), then 1−0.90=0.10(10%) Percentage Heat. At block 106, controller 20 determines a Battery Heat Generated based on the Percentage Heat multiplied by the previously determined Battery Discharge Power.

At block 108, controller 20 determines a total battery heat energy (e.g., in kWh) that needs to be cooled (kWhrs Heat Generated) to cool the HV battery 18 to a predetermined maximum battery temperature allowed. In the example embodiment, controller 20 integrates the Battery Heat Generated over a time since the predetermined maximum temperature allowed was surpassed.

At block 110, controller 20 determines a battery heat generation to be dissipated to cool the HV battery 18 back to the maximum temperature allowed (kWh Heat Gen Used). At this block, controller 20 first determines IF a temperature of the HV battery 18 is less than the predetermined maximum temperature allowed. If true, THEN the previously determined kWhrs Heat Generated is utilized as the output kWh Heat Gen Used. If false (ELSE), then at multiplication block 112, controller 20 sets the output kWh Heat Gen Used as the temperature of the HV battery 18 over the predetermined maximum temperature allowed (Cell Over Temp) multiplied by a known/determined constant of energy required to increase the HV battery temperature a predetermined amount (e.g., 1° C.) (kWh to Increase 1° C.). Block 112 may be utilized, for example, when the HV battery 18 wakes and the ambient temperature is above the predetermined maximum temperature allowed. In this way, the output of block 110 is a measure of kWh of battery heat generation that needs to be dissipated. In other words, how much heat energy above the predetermined maximum temperature allowed has already been generated that needs to be cooled.

Once the amount of heat energy to be dissipated is determined, the control determines how much time will be allowed to cool the HV battery 18 to below the maximum temperature allowed. Accordingly, at block 116, controller 20 determines a Desired Time to Cool since the predetermined maximum temperature was surpassed. The Desired Time to Cool is a calibratable time based on various factors and conditions for a particular vehicle and/or HV battery. For example, as shown in the illustrated control, the Desired Time to Cool may be based on inputs such as the battery cell temperature, ambient temperature, and/or a thermal state of the HV battery cooling system 16 and/or HV battery 18. In one example, the Desired Time to Cool may be twenty minutes from the time the maximum temperature allowed was surpassed. However, if the ambient temperature is above a certain temperature, the HV battery cooling system 16 may set a Desired Time to Cool to ten minutes instead of twenty minutes.

Once the Desired Time to Cool is determined, the control determines/predicts how much additional heat energy (Predicted Battery Heat Generation kWh) will be generated by the HV battery 18 during the remaining Desired Time to Cool. In other words, control determines how much future battery heat energy generation will need to be dissipated to cool the HV battery 18 below the maximum temperature allowed.

Accordingly, at multiplication block 118, controller 20 determines the Predicted Battery Heat Generation kWh by multiplying the Desired Time to Cool by a rolling average of the additional battery heat energy that will be generated during the remaining Desired Time to Cool. The rolling average of battery heat energy generated is calibratable and may be based on various factors and conditions for a particular vehicle and/or HV battery. In one example, the rolling average is latched or “frozen” once active cooling of the HV battery 18 begins. Additionally, the rolling average may include a rate limiter and/or filter.

Once the Predicted Battery Heat Generation kWh is determined, control then determines/predicts how much total battery heat energy generated will need to be cooled by the end of the Desired Time to Cool. Accordingly, at block 120, controller 20 determines/predicts how much generated battery heat energy (Predicted kWh to Cool) must be dissipated during the Desired Time to Cool to thereby cool the HV battery 18 down to the max temp allowed. In the example embodiment, controller 20 determines the Predicted kWh to Cool by adding the kWh Heat Gen Used (output of block 110) and the Predicted Battery Heat Generation kWh (output of block 118). In other words, block 110 determines how much heat energy above max temp allowed has already been generated, and block 118 determines how much additional heat energy will be generated during the desired time to cool since the max temp allowed was surpassed.

At block 122, controller 20 determines/predicts how much time it will take to cool the HV battery 18 to below the predetermined maximum temperature allowed when one or more components of the HV battery cooling system 16 are operated within a predetermined power efficiency zone (Predicted Time to Cool at Most Efficient). In the example embodiment, the one or more components include at least one of the BCP 32 and the EAC 60, and the Predicted Time to Cool at Most Efficient is determined by dividing the Predicted kWh to Cool by the most efficient battery cooling power of the component (e.g., a predetermined power efficiency zone of the component).

In one example, the predetermined power efficiency zone for the component is determined based on a power curve of the component (e.g., provided by the component manufacturer, testing, etc.). The predetermined power efficiency zone is selected for a certain RPM and pressure range where that component operates at a desired energy and/or cooling efficiency (e.g., most efficient, efficiency >90%, etc.). Such an operation is unlike conventional cooling, where the component is merely operated at a certain RPM for every degree over-temperature, not taking into account what is most efficient for the component.

At block 124, controller 20 determines how much time remains in the Desired Time to Cool by subtracting the time since the maximum temperature allowed was surpassed from the Desired Time to Cool (block 116). At block 126, controller 20 determines if the HV battery cooling system 16 should begin cooling the HV battery 18. To make this determination, controller 20 first determines if the Predicted Time to Cool at Most Efficient is greater than or equal to the time remaining in the Desired Time to Cool (block 124). If yes, controller 20 begins cooling the HV battery 18. If no, controller 20 does not begin cooling the HV battery 18. Accordingly, blocks 102-126 determine when controller 20 is to begin cooling of the HV battery 18, and controller 20 subsequently opens CRV 78 at that time. Controller 20 is configured to close CRV 78 when active cooling ends and the HV battery 18 is below the temperature target (e.g., maximum allowable battery temperature).

Turning now to FIG. 3, the control strategy 200 for determining how to operate the BCP 32, EAC 60, and CRV 78 once cooling of the HV battery 18 begins (determined in blocks 102-126) is described in more detail. The control strategy 200 begins at block 202 and controller 20 subtracts the rolling average of the additional battery heat energy that will be generated during the remaining Desired Time to Cool (block 118) from Battery Heat Generated (block 106) to thereby determine a Battery Heat Over Gen. In one example, the rolling average of the additional battery heat energy is frozen (e.g., kept constant) because cooling has just begun and a certain battery heat energy generation over the predicted time is assumed. In this way, block 202 accounts for changes in driving behavior that will increase or reduce the generated battery heat energy.

Further, in the example implementation, Battery Heat Over Gen is a correction to the predicted heat generation, which is used to determine when to begin cooling. Once cooling begins, the control analyzes Battery Heat Over Gen to determine how much cooling is actually needed. For example, say the predicted heat generation states the system has 5.0 kWhrs of battery heat to cool over a twenty minute allowed over temp period, and the vehicle was driving gently such that cooling began ten minutes into the twenty minutes allowed over temp. However, as soon as cooling began, the vehicle started driving more aggressively such that the control now determines there will be 8.0 kWhrs of battery heat to cool, the additional 3.0 kWhrs that the predicted heat generation did not predict are accounted for in the Battery Heat Over Gen.

At block 204, controller 20 integrates the Battery Heat Over Gen over the time since active cooling began to determine an additional generated heat energy to dissipate (Battery Heat Over Gen kWh). At block 206, controller 20 divides the Battery Heat Over Gen kWh by a Predicted Time to Completion Limit to determine how much additional battery cooling power is needed to cool the HV battery 18 below the maximum allowed temperature (Additional Cooling Power Needed). This value is given a predetermined limit to ensure the additional battery cooling power needed is not outside of the capability of the HV battery cooling system 16. The Predicted Time to Completion Limit is determined in blocks 208-214 and is configured to modify a predicted time to completion based on the additional heat generation of Battery Heat Over Gen kWh.

Turning now to block 208, controller 20 determines if the Predicted Time to Cool at Most Efficient (block 122) is greater than the Desired Time to Cool (block 116). If true, at block 210, controller 20 selects the Desired Time to Cool as the output (Predicted Time to Cool) to block 212. If false, controller 20 instead selects the Predicted Time to Cool at Most Efficient as the output (Predicted Time to Cool) to block 212.

At block 212, controller 20 subtracts the time since active cooling began from the Predicted Time to Cool (block 210) to determine a predicted time to cool the HV battery 18 to the max allowable temperature (Predicted Time to Completion). At block 214, controller 20 sets a predetermined limiter to the Predicted Time to Completion (block 212) to determine the Predicted Time to Completion Limit. In one example, the predetermined limiter is a lower limit set such that additional cooling power sets maximum cooling without dividing by zero. The output Predicted Time to Completion Limit is then utilized as input into block 204 to determine the Additional Cooling Power Needed.

At block 216, controller 20 adds the Additional Cooling Power Needed (block 204) to a Previous Battery Cooling Power Needed to determine an updated amount of cooling power needed to cool the HV battery 18 to below the maximum allowable temperature (Updated Battery Cooling Power Needed). The Previous Battery Cooling Power Needed may be obtained from the block 216 output of a previous iteration of control strategy 200. In this way, the control strategy 200 is looped to continuously update the battery cooling power needed with additional cooling power needed (block 204) as the driving behavior of the driver changes and the HV battery 18 continues to generate heat.

However, if this is the first iteration or loop of control strategy 200 (e.g., since the vehicle is keyed on), the Previous Battery Cooling Power Needed is replaced with an Initial Battery Cooling Power Needed, which is determined in blocks 218-224. To determine the Initial Battery Cooling Power Needed, at block 218, controller 20 determines if the Predicted Time to Cool at Most Efficient (block 122) is greater than or equal to the time remaining in the Desired Time to Cool (block 124). If yes, then at block 220, controller 20 divides the Predicted kWh to Cool (block 120) by the Desired Time to Cool (block 116) and block 222 outputs this result as the Initial Battery Cooling Power Needed. If no, then controller 20 outputs the most efficient battery cooling power of the component(s) as the Initial Battery Cooling Power Needed. At block 224, controller 20 applies a limiter to the Initial Battery Cooling Power Needed, for example, to maintain system or component operation within a predetermined efficiency limit. The Initial Battery Cooling Power Needed is then input into block 214 to determine the Updated Battery Cooling Power Needed.

Once the Updated Battery Cooling Power Needed is determined in block 216, then at block 226, controller 20 multiplies the Battery Cooling Power Needed by a correction factor to determine a Corrected Battery Cooling Power Needed. The correction factor is to account for various system inaccuracies like inaccurate manufacturer heat generation info, and/or additional heat generation (or losses) from components such as coolant hoses. At block 228, controller 20 applies a limiter to the Corrected Battery Cooling Power Needed, for example, to exclude conditions or operations that cannot be performed by the HV battery cooling system 16. Block 228 thus provides a Corrected Battery Cooling Power Needed Limit. In the example embodiment, the limiter maintains the Corrected Battery Cooling Power Needed between a maximum cooling power and the most efficient cooling power for one or more components such as BCP 32 and EAC 60.

At block 230, controller 20 refers to a stored lookup table that charts various operating speeds (e.g., RPM's) for the BCP 32 and/or the EAC 60 and a corresponding Battery Cooling Power produced by the BCP 32 and/or EAC 60 when operating at those speeds. For example, the lookup table may show that if BCP 32 is operated at 5800 RPM and EAC 60 is operated at 8400 RPM, the HV battery cooling system 16 will provide approximately 8.0 KW of battery cooling power.

The controller 20 then selects the Battery Cooling Power in the lookup table that matches or most closely matches the Corrected Battery Cooling Power Needed Limit from block 228, and identifies the corresponding RPM for BCP 32 and EAC 60. Moreover, the lookup table may be arranged in order of efficiency such that controller 20 first selects the most efficient operating speed of BCP 32 and EAC 60 that meet the Battery Cooling Power requirement. At block 232, controller 20 then opens the CRV 78 (if not open) and commands the BCP 32 and/or EAC 60 to operate at the most efficient selected speed. Control may then be repeated or loop at various points to account for any changes in the vehicle or system such as, for example, a change in driving behavior.

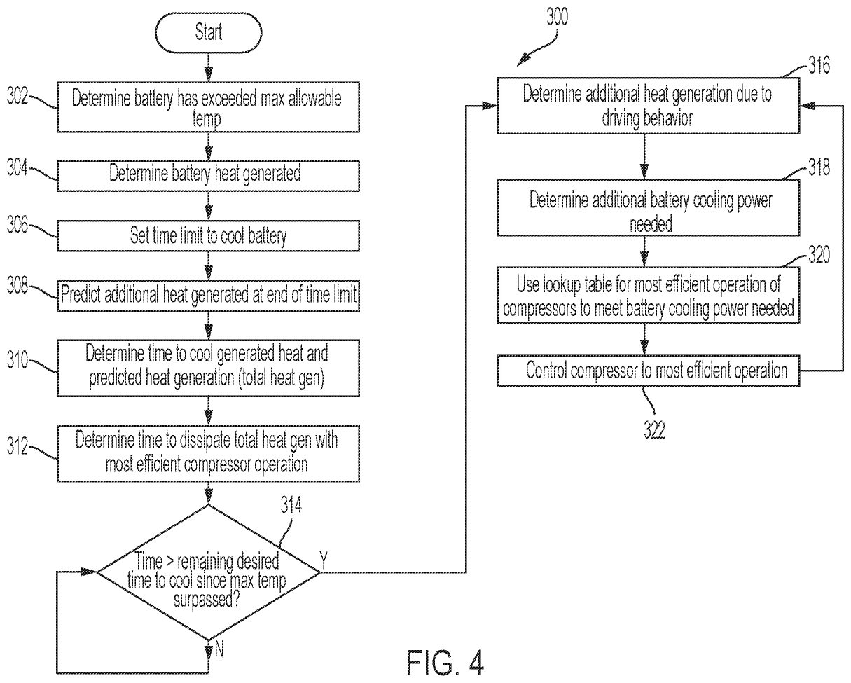

With reference now to FIG. 4, an example computer-implemented method 300 of operating HV battery cooling system 16 to cool HV battery 18 is provided. The method begins at step 302 where controller 20 determines a temperature of the HV battery 18 has exceeded a predetermined maximum allowable battery temperature. At step 304, controller 20 determines how much heat energy has been generated by the HV battery 18 (e.g., see block 106). At step 306, controller 20 determines or sets a time limit to cool the HV battery 18 to maintain its temperature at or below the maximum allowable battery temperature (e.g., see block 116). In one example, the time limit to cool is based on vehicle driving behavior. For example, if the vehicle is being driven aggressively, controller 20 may set a relatively shorter time limit to cool, while if the vehicle is being driven non-aggressively, controller 20 may set a relatively longer time limit to cool.

At step 308, controller 20 determines how much additional heat energy will be generated by the HV battery 18 by the end of the time limit to cool (e.g., see block 118). At step 310, controller determines a total battery heat generated to cool based on the sum of the generated heat energy (step 304) and the predicted additional generated heat energy (step 308) (e.g., see block 120). At step 312, controller 20 determines how much time it will take to dissipate the total battery heat generated when operating BCP 32 and EAC 60 at their most efficient operation (e.g., see block 122).

At step 314, controller 20 determines if the time to dissipate the total battery heat generated (step 312) is greater than the remaining time limit to cool since the maximum allowable battery temperature was surpassed and activates active cooling. If no, controller returns to step 314. If yes, controller 20 opens CRV 78 and operates BCP 32 and/or EAC 60 according to the following steps.

At step 316, controller 20 determines any additional battery heat energy generation due to a change in driving behavior (e.g., see block 204) after active cooling is initiated and during the time limit to cool. At step 318, controller 20 determines an additional battery cooling power needed to cool the additional heat energy generation (step 316) (e.g., see block 206). At step 320, controller 20 utilizes a lookup table to determine the most efficient operation (rpm) of BCP 32 and EAC 60 that will meet the battery cooling power needed (step 316) (e.g., see block 230). At step 322, controller 20 then opens CRV 78 and commands the BCP 32 and/or EAC 60 to operate at the efficient operation determined in step 320. Control may then end or return to step 314 or 316.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric vehicle thermal system comprising:
a battery system coolant loop including a battery coolant pump (BCP) configured to circulate a first coolant for cooling a high voltage (HV) battery;
an HVAC loop including a compressor and a chiller thermally coupled to the battery system coolant loop, the compressor configured to circulate a second coolant to the chiller to provide cooling to the battery system coolant loop; and
an HV battery cooling system including a controller in signal communication with the BCP, the compressor, and a flow control valve of the chiller,
wherein the controller includes one or more processors configured to execute an adaptive cooling strategy operation to proactively cool the HV battery, comprising:
determining the HV battery has surpassed a predetermined maximum allowable battery temperature;
determining a Desired Time to Cool the HV battery to or below the maximum allowable battery temperature; and
initiating an active cooling of the HV battery by opening the chiller flow control valve and operating the BCP and/or the compressor to cool the HV battery to or below the maximum allowable battery temperature within the Desired Time to Cool the HV battery.

2. The electric vehicle thermal system of claim 1, wherein the controller initiates the active cooling when a predicted time to cool the HV battery to or below the maximum allowable battery temperature while operating the BCP and/or the compressor in a predetermined power efficiency zone, is less than a time remaining of the Desired Time to Cool since the predetermined maximum allowable battery temperature was surpassed.

3. The electric vehicle thermal system of claim 2, wherein the predetermined power efficiency zone is a most efficient operation of the BCP and compressor.

4. The electric vehicle thermal system of claim 2, wherein the controller determines the predicted time to cool the HV battery by:
determining how much generated battery heat energy must be dissipated during the Desired Time to Cool, and subsequently dividing by a most efficient operation of the BCP and compressor.

5. The electric vehicle thermal system of claim 4, wherein the controller determines how much generated battery heat energy must be dissipated during the Desired Time to Cool by:
determining a total battery heat energy generated by the HV battery that comprises the sum of (i) how much heat energy has been generated by the HV battery and (ii) how much additional heat energy will be generated by the HV battery by the end of the Desired Time to Cool.

6. The electric vehicle thermal system of claim 5, wherein the controller determines the additional heat energy generated by the HV battery by the end of the Desired Time to Cool by:
multiplying the Desired Time to Cool by a rolling average of additional battery heat energy that will be generated during the remaining Desired Time to Cool.

7. The electric vehicle thermal system of claim 6, wherein the controller determines how much heat energy has been generated by the HV battery by:
determining a battery efficiency of the HV battery;
determining a percentage of battery discharge power that is being converted into heat, based on the determined battery efficiency;
determining a battery heat generated by the HV battery based on the percentage of battery discharge power being converted into heat and a determined battery discharge power of the HV battery; and
integrating the battery heat generated over a time since the predetermined maximum allowable battery temperature was surpassed.

8. The electric vehicle thermal system of claim 1, wherein once the active cooling is initiated, the controller further executes the adaptive cooling strategy operation to proactively cool the HV battery by:
determining any additional battery heat energy generated by the HV battery during the Desired Time to Cool due to a change in driving behavior;
determining an additional battery cooling power needed to cool the additional battery heat energy generated by the HV battery during the Desired Time to Cool due to a change in driving behavior;
determining a first operational speed of the BCP and a second operational speed of the compressor required to provide the determined additional battery cooling power needed;
commanding the BCP to operate at the first operational speed; and
commanding the compressor to operate at the second operational speed.

9. The electric vehicle thermal system of claim 8, wherein the first operational speed and the second operational speed are the most efficient operational speeds of the BCP and the compressor to provide the determined additional battery cooling power needed.

10. The electric vehicle thermal system of claim 9, wherein the controller determines the first and second operational speeds based on a lookup table that charts various operating speeds of the BCP and compressor and a corresponding battery cooling power produced by the BCP and compressor when operating at those various operating speeds.

11. A method for adaptively cooling a high voltage (HV) battery in an electric vehicle thermal system that comprises:
a battery system coolant loop including a battery coolant pump (BCP) configured to circulate a first coolant for cooling the HV battery;
an HVAC loop including a compressor and a chiller thermally coupled to the battery system coolant loop, the compressor configured to circulate a second coolant to the chiller to provide cooling to the battery system coolant loop; and
an HV battery cooling system including a controller, having one or more processors, in signal communication with the BCP, the compressor, and a flow control valve of the chiller, the method comprising:
determining, with controller, the HV battery has surpassed a predetermined maximum allowable battery temperature;
determining, with the controller, a Desired Time to Cool the HV battery to or below the maximum allowable battery temperature; and
initiating, with the controller, an active cooling of the HV battery by opening the chiller flow control valve and operating the BCP and/or the compressor to cool the HV battery to or below the maximum allowable battery temperature within the Desired Time to Cool the HV battery.

12. The method of claim 11, wherein the controller initiates the active cooling when a predicted time to cool the HV battery to or below the maximum allowable battery temperature while operating the BCP and/or the compressor in a predetermined power efficiency zone, is less than a time remaining of the Desired Time to Cool since the predetermined maximum allowable battery temperature was surpassed.

13. The method of claim 12, wherein the predetermined power efficiency zone is a most efficient operation of the BCP and compressor.

14. The method of claim 12, wherein the controller determines the predicted time to cool the HV battery by:
determining how much generated battery heat energy must be dissipated during the Desired Time to Cool, and subsequently dividing by a most efficient operation of the BCP and compressor.

15. The method of claim 14, wherein the controller determines how much generated battery heat energy must be dissipated during the Desired Time to Cool by:
determining a total battery heat energy generated by the HV battery that comprises the sum of (i) how much heat energy has been generated by the HV battery and (ii) how much additional heat energy will be generated by the HV battery by the end of the Desired Time to Cool.

16. The method of claim 15, wherein the controller determines the additional heat energy generated by the HV battery by the end of the Desired Time to Cool by:
multiplying the Desired Time to Cool by a rolling average of additional battery heat energy that will be generated during the remaining Desired Time to Cool.

17. The method of claim 16, wherein the controller determines how much heat energy has been generated by the HV battery by:
determining a battery efficiency of the HV battery;
determining a percentage of battery discharge power that is being converted into heat, based on the determined battery efficiency;
determining a battery heat generated by the HV battery based on the percentage of battery discharge power being converted into heat and a determined battery discharge power of the HV battery; and
integrating the battery heat generated over a time since the predetermined maximum allowable battery temperature was surpassed.

18. The method of claim 11, further comprising:
once the active cooling is initiated, determining, with the controller, any additional battery heat energy generated by the HV battery during the Desired Time to Cool due to a change in driving behavior;
determining, with the controller, an additional battery cooling power needed to cool the additional battery heat energy generated by the HV battery during the Desired Time to Cool due to a change in driving behavior;
determining, with the controller, a first operational speed of the BCP and a second operational speed of the compressor required to provide the determined additional battery cooling power needed;
commanding, with the controller, the BCP to operate at the first operational speed; and
commanding, with the controller, the compressor to operate at the second operational speed.

19. The method of claim 18, wherein the first operational speed and the second operational speed are the most efficient operational speeds of the BCP and the compressor to provide the determined additional battery cooling power needed.

20. The method of claim 19, wherein the controller determines the first and second operational speeds based on a lookup table that charts various operating speeds of the BCP and compressor and a corresponding battery cooling power produced by the BCP and compressor when operating at those various operating speeds.
